(19) United States
(12) Patent Application Publication
(10) Pub. No.: US 2025/0364795 A1
(43) Pub. Date: Nov. 27, 2025

(54) CONVEYOR WIRING MOUNTS

(71) Applicant: Norman R. Byrne, Ada, MI (US)

(72) Inventors: Daniel P. Byrne, Lowell, MI (US); Joseph Luedtke, Grand Rapids, MI (US); Marc A. Mitchell, Jupiter, FL (US); Parker Genau, Grand Rapids, MI (US)

(21) Appl. No.: 19/216,312

(22) Filed: May 22, 2025

Related U.S. Application Data
(60) Provisional application No. 63/650,671, filed on May 22, 2024.

(51) Int. Cl. H02G 3/32

(52) U.S. Cl. CPC H02G 3/32

(57) ABSTRACT

Wiring mounts support and readily release wires or cables of a modular electrical system of a conveyor system, such as one assembled from conveyor modules. The wiring mounts releasably support the cables and cords at desired locations relative to the conveyor module structures, typically along the outboard face of a horizontal beam, below the horizontal beam, or below and laterally inboard of the beam. The wiring mounts may be fitted with spring clips that readily receive, retain, and release cords or cables, and may also have removable portions that can provide temporary support for the cords or cables, while also facilitating removal of the cords and cables when desired.

### CROSS REFERENCE TO RELATED APPLICATION

The present application claims the benefit of U.S. provisional application Ser. No. 63/650,671 filed May 22, 2024, which is hereby incorporated herein by reference in its entirety.

### FIELD

The present disclosure relates to electrical systems for electrically powered and/or electronically controlled conveyor systems.

### BACKGROUND

Electrically powered conveyor systems are used for directing loose goods and packages from a receiving area to a depositing area. In some cases it is desirable to set up conveyors made up of multiple conveyor sections, and which can be relocated or replaced if the conveyor layout is to be changed, or for servicing.

### SUMMARY

The present disclosure provides wiring mounts for supporting wires or cables of a modular electrical system for electrical power cables and/or electronic data cords associated with a conveyor system made up of conveyor modules. The modular electrical system utilizes a plurality of wiring mounts for releasably supporting the cables and cords at desired locations relative to the conveyor module structures, typically along the outboard face of a horizontal beam, below the horizontal beam, or below and laterally inboard of the beam. The wiring mounts may be fitted with spring clips that readily receive, retain, and release cords or cables, and may also have removable portions that provide temporary support for the cords or cables, while also facilitating removal of the cords and cables when desired.

According to one form, a wiring mount for conveyor systems includes a bracket, a fitting for a fastener, and a cable retainer, which can together be secured to a conveyor or conveyor segment. The bracket has a cable support plate and at least one mounting leg angled away from the cable support plate. The mounting leg couples the cable support plate to a conveyor or conveyor segment. The fitting receives or supports a fastener for coupling to the conveyor or conveyor segment. The cable retainer has a base and a resilient clip portion that extends away from the base, and can releasably receive an electrical cable. The base couples to the cable support plate, and the resilient clip portion defines a channel opening that opens away from the main support plate.

In one aspect, the cable retainer is arranged so that when the base is coupled to the cable support plate, the resilient clip portion extends laterally outboard of the cable support plate.

In another aspect, the cable retainer is arranged so that when the base is coupled to the cable support plate, the resilient clip portion is spaced away from the cable support plate.

In yet another aspect, the bracket further comprises a closure plate and a closure plate receiver leg. The closure plate receiver leg is angled to extend away from the cable support plate, and the closure plate is configured to removably couple to the closure plate receiver leg.

Optionally, when the closure plate is coupled to the closure plate receiver leg, the closure plate extends along the channel opening to restrict access to the channel opening. The closure plate receiver leg and the closure plate may include respective compatible coupler portions configured to engage one another when the closure plate is coupled to the closure plate receiver leg. Optionally, the compatible coupler portions are formed by a slot at the closure plate receiver leg and a tab formed at the closure plate.

In a further aspect, the mounting leg has at least two spaced-apart mounting feet. Optionally, the spaced-apart mounting feet are generally parallel to the cable support plate and are spaced from the cable support plate by different distances.

According to another form, a wiring mount for conveyor systems includes a cable support plate having opposite end portions, a mounting leg at each opposite end portion, a pair of tab-receiving slots formed in the cable support plate, and a cable retainer. The mounting legs each extend away from the cable support plate, and are configured to be secured to a conveyor module. The tab-receiving slots extend between the opposite end portions of the cable support plate. The cable retainer has a base, a tab extending away from the base, and a resilient clip portion spaced from the tab. The clip portion extends away from the base and is configured to releasably receive an electrical cable. The cable retainer is releasably securable to the cable support plate in either of at least two different orientations. The tab of the cable retainer is received in one of the tab-receiving slots upon securing the cable retainer base to the cable support plate according to the orientation of the cable retainer.

According to still another form, a wiring mount for conveyor systems includes a cable support plate with upper and lower end portions, a mounting leg at the upper end portion, an upward-extending tab at an outboard end of the mounting leg, a pair of spacer tabs, and a cable retainer. The mounting leg extends away from the cable support plate and is securable to a conveyor module. The upward-extending tab has a first height, while a pair of spacer tabs extend upwardly from opposite sides of the mounting leg and have a second height that is less than the first height. The spacer tabs are configured to engage a portion of a conveyor module, and the upward-extending tab is configured to extend upwardly along the portion of the conveyor module. The cable retainer includes a base and a resilient clip portion that extends away from the base and can releasably receive an electrical cable. The cable retainer is releasably securable to the cable support plate in either of at least two different orientations.

Thus, the wiring mounts provide convenient and secure but releasable mounting features along a conveyor system or module, for supporting wires or cables of an electrical system including electrical power cables and/or electronic data cords associated with the conveyor system. When used with a modular conveyor system, the ability to temporarily retain cables, cords, or wires using spring clips, shelf-like surfaces, removable trays, or the like, facilitates assembly, disassembly, and reconfiguring the conveyor for new applications.

These and other objects, advantages, purposes and features of this disclosure will become apparent upon review of the following specification in conjunction with the drawings.

### BRIEF DESCRIPTION OF THE DRAWINGS

FIG. 1 is a perspective view of a portion of a conveyor segment fitted with conveyor wiring mounts;

FIG. 2 is an enlarged view of the area designated II in FIG. 1;

FIG. 3 is another perspective view of the conveyor segment and wiring mounts of FIG. 1, shown with a single cable routed through each of the upper wiring mount and one of the lower wiring mounts;

FIG. 4 is an enlarged view of the area designated IV in FIG. 3;

FIG. 5 is another perspective view of the conveyor segment and wiring mounts of FIG. 1, shown with a single cable routed through one of the lower wiring mounts and three cables routed through the upper wiring mount;

FIG. 6 is an enlarged view of the area designated VI in FIG. 5;

FIG. 7 is another perspective view of the conveyor segment and wiring mounts of FIG. 1, shown with the upper wiring mount in a reverse orientation;

FIG. 8 is an enlarged view of the area designated VIII in FIG. 7;

FIG. 9 is an enlarged front perspective view of the bracket portion of the upper wiring mount of FIG. 1;

FIG. 10 is an enlarged front perspective view of the upper wiring mount of FIG. 3;

FIG. 11 is an enlarged rear perspective view of the upper wiring mount of FIG. 3;

FIG. 12 is another perspective view of the conveyor segment of FIG. 1, shown fitted with a single conveyor wiring mount;

FIG. 13 is an enlarged view of the area designated XII in FIG. 12;

FIG. 14 is an end elevation view of the conveyor segment and conveyor wiring mount of FIG. 12;

FIG. 15 is an enlarged perspective view of the conveyor wiring mount of FIGS. 13 and 14;

FIG. 16 is an enlarged perspective view of the conveyor wiring mount of FIGS. 13 and 14, shown without cable retainers;

FIG. 17 is an exploded perspective view of the conveyor wiring mount of FIG. 16;

FIG. 18 is another perspective view of the conveyor segment of FIG. 1, shown fitted with a single conveyor wiring mount;

FIG. 19 is an end elevation view of the conveyor segment and conveyor wiring mount of FIG. 18;

FIG. 20 is an enlarged front perspective view of the bracket portion of the conveyor wiring mount of FIGS. 18 and 19;

FIG. 21 is an enlarged front perspective view of the conveyor wiring mount of FIGS. 18 and 19;

FIG. 22 is an enlarged rear perspective view of the conveyor wiring mount of FIGS. 18 and 19; and

FIGS. 23-25 are perspective views of cable retainers of the wiring mounts.

### DESCRIPTION OF THE PREFERRED EMBODIMENTS

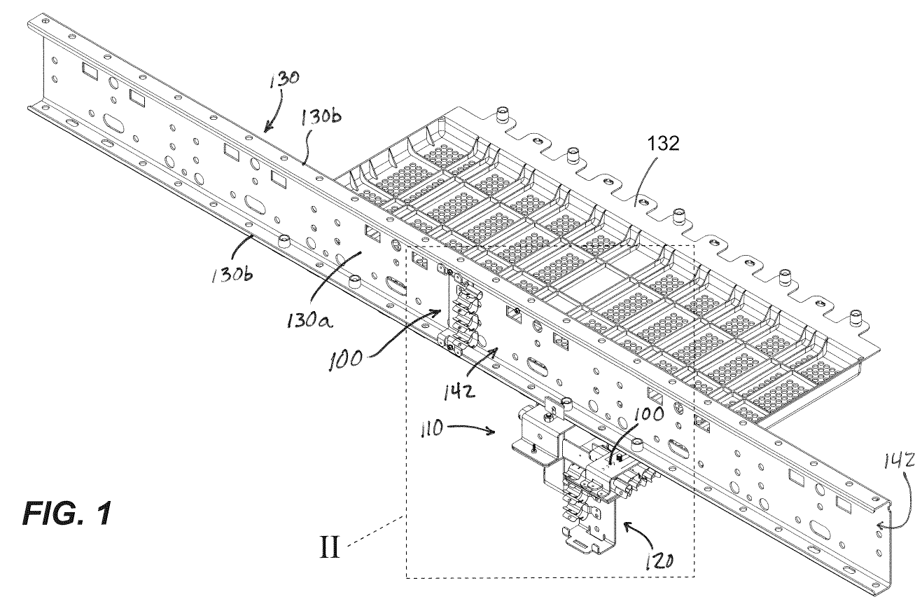

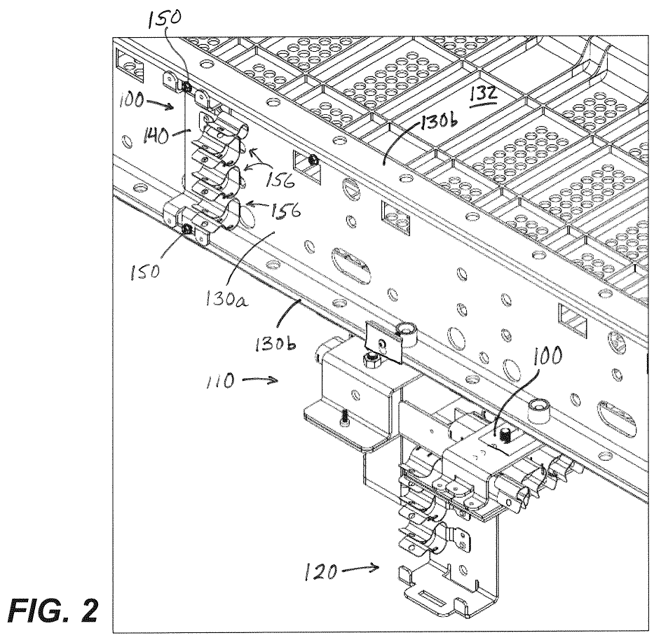

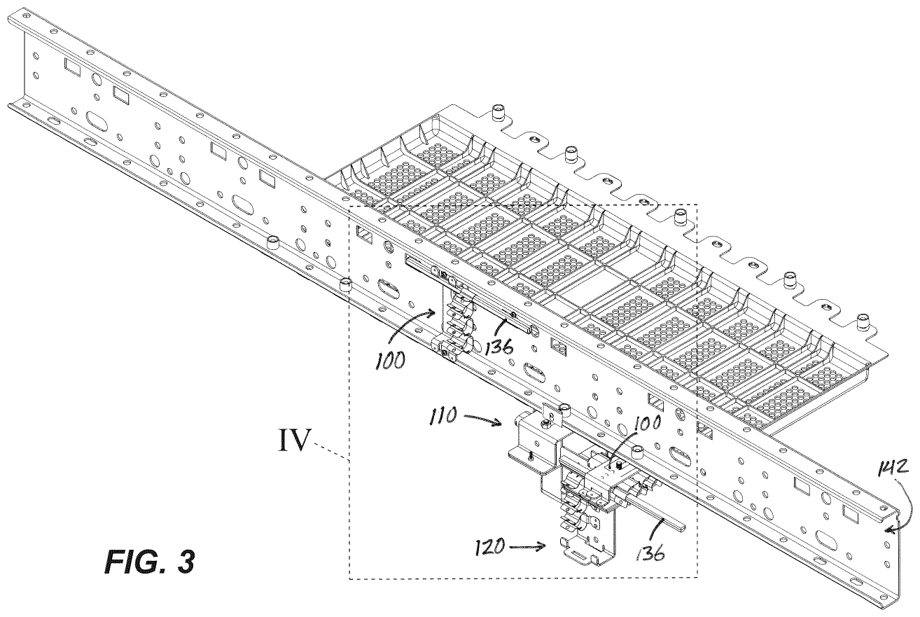

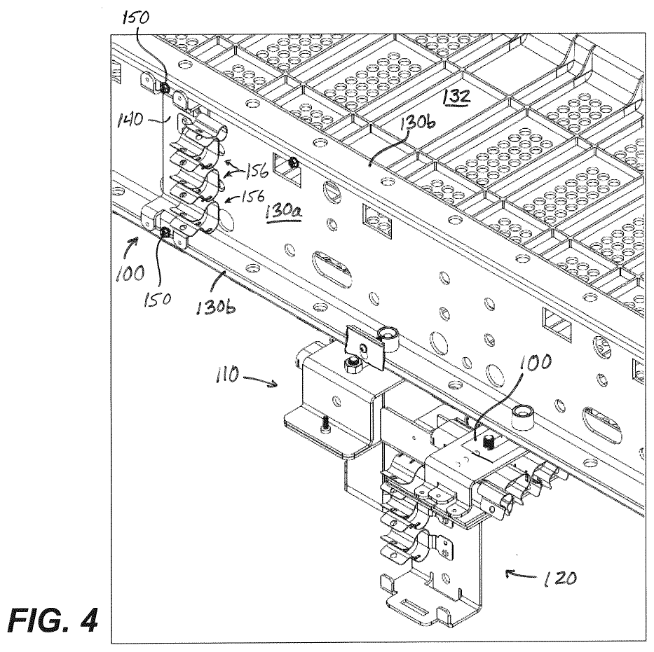

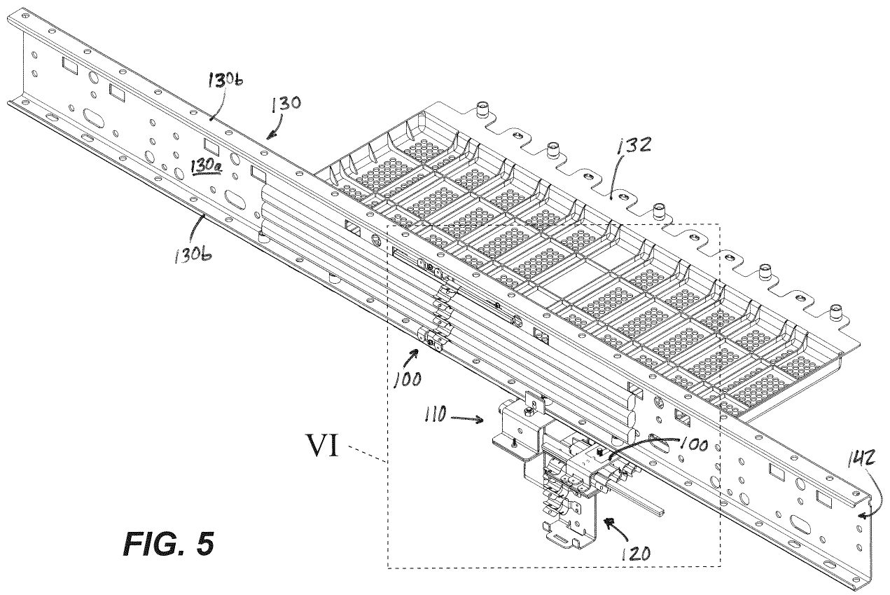

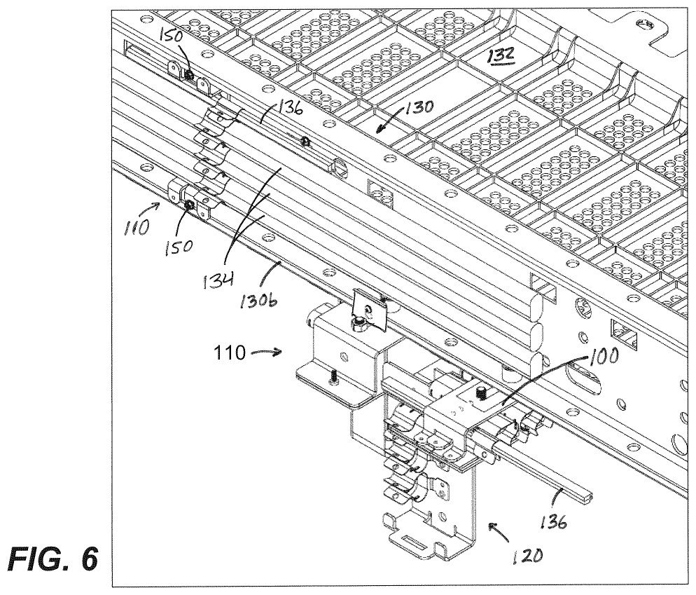

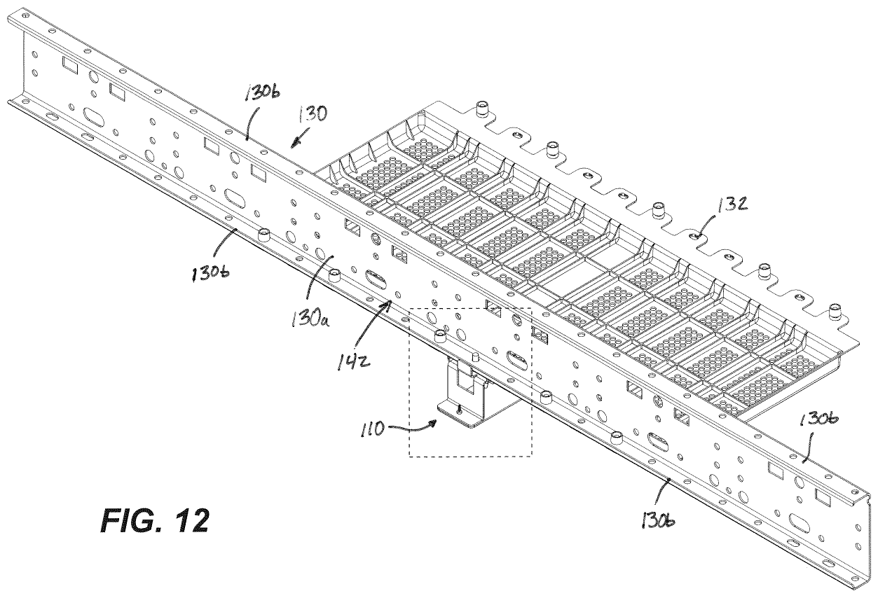

Referring now to the drawings and illustrative embodiments depicted therein, wiring mounts 100, 110, 120 are provided for attachment to a conveyor system such as a modular conveyor made up of separable components such as shown in FIGS. 1-8 and 12-14. In the drawings, the conveyor system is represented by a horizontal frame rail 130 and a support tray 132 that extends inboard from frame rail 130. The support tray 132 extends beneath a belt or roller conveyor that is typically driven by one or more electric motors, and is supported on its opposite side by another horizontal frame rail. Wiring mounts 100, 110, 120 facilitate and simplify supporting electrical power cables 134 and/or electronic data or controls wiring 136 (each referred to collectively or generically as “cables” or “wiring”) along the horizontal frame rail 130. The cables 134 and wiring 136 may be temporarily supported by the wiring mounts 100, 110, 120 during assembly of the conveyor system, during servicing, and the like, and the cables 134 and wiring 136 may be supported by the wiring mounts in the same or a different manner during operation of the conveyor system.

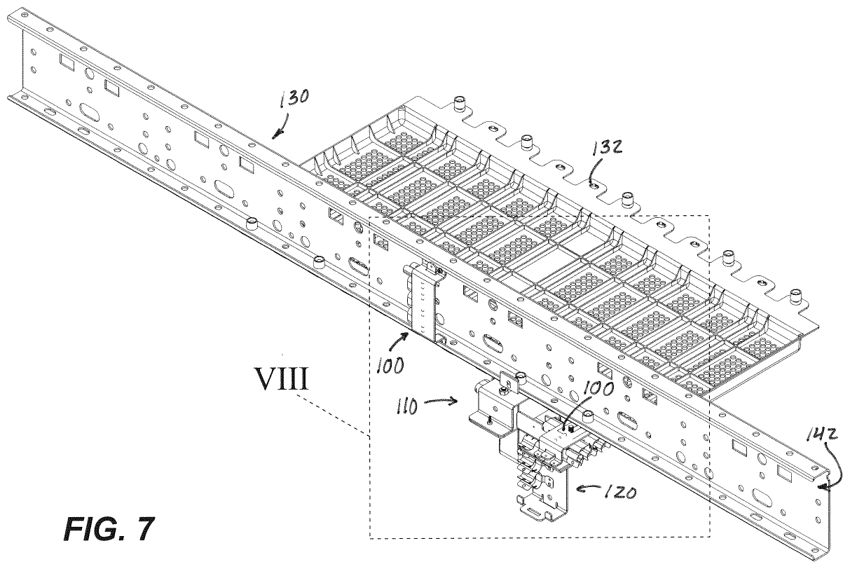

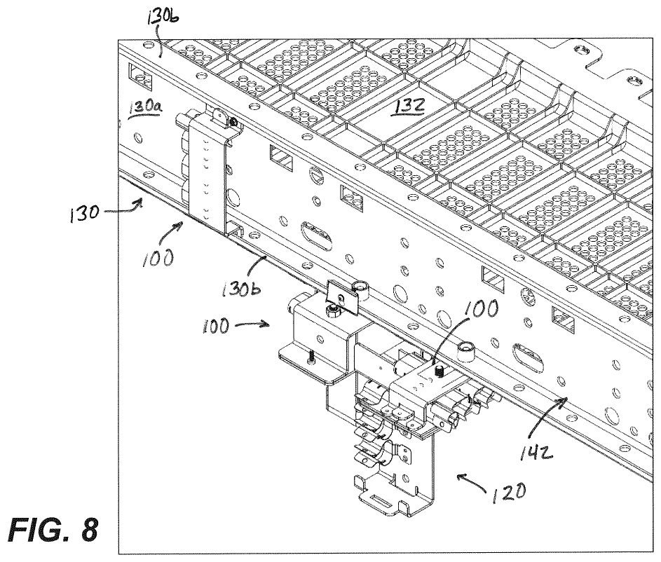

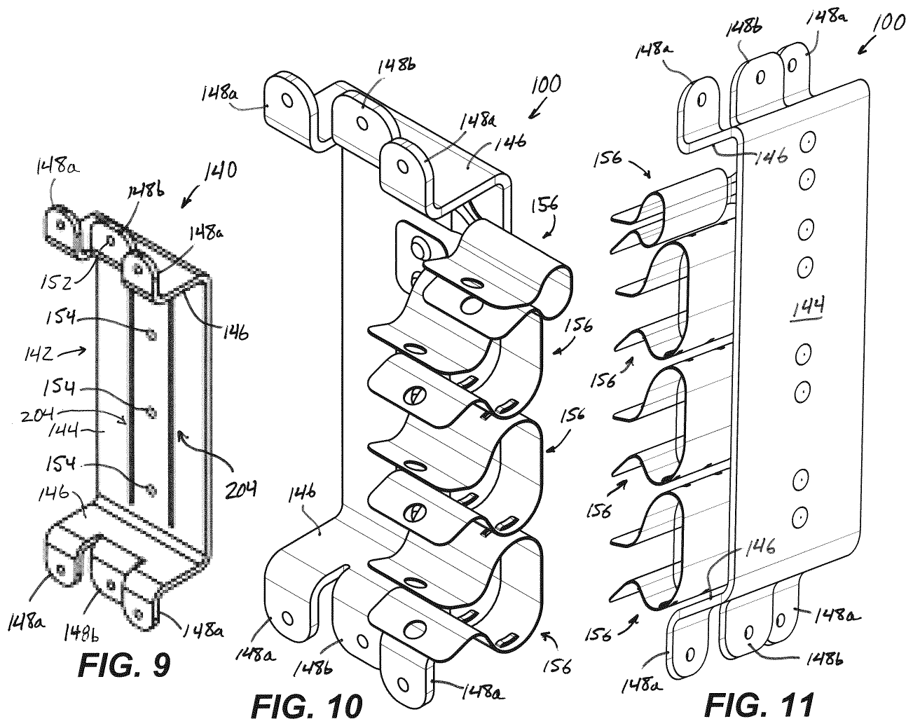

Wiring mount 100 is formed from a generally U-shaped bracket 140 that is sized and shaped to be received in an outboard-facing channel 142 formed in the conveyor system's frame rail 130 as shown in FIGS. 1-6. U-shaped bracket 140 has a cable support plate 144 and a pair of mounting legs 146 that extend perpendicularly away from support plate 144, and then terminate in outboard-extending feet 148a, 148b, as best shown in FIGS. 9-11. In FIGS. 1-6 the U-shaped bracket 140 is mounted with its cable support plate 144 secured against a main upright plate 130a of the horizontal frame rail 130, between upper and lower horizontal legs 130b. Central feet 148b of bracket 140 are secured to the respective legs 130b of the frame rail 130 using fasteners 150 that extend through fittings in the central feet 148b in the form of fastener openings 152 (FIGS. 9-11). Additional fastener openings 154 are formed along cable support plate 144, which are primarily for attaching cable retainers 156 in the form of spring-clips, but which may optionally be used for attaching U-shaped bracket 140 to the frame rail 130 as shown in FIGS. 1-8 in which one of the wiring mounts 100 is shown mounted to a downward-facing surface of the lower horizontal leg 130b of the conveyor's frame rail 130. Outboard feet 148a located on either side of central feet 148b allow for additional mounting options for the U-shaped bracket 140, or for attaching other structures such as a cover plate. Optionally, and as shown in FIGS. 7 and 8, one or more fasteners 150 may be used to secure the outboard feet 148a to horizontal frame rail 130 with wiring mount 100 in a reverse orientation in which the U-shaped bracket's channel 142 is facing the main upright plate 130a of the horizontal frame rail 130. In the illustrated embodiment, central feet 148b are positioned closer to cable support plate 144 than are outboard feet 148a. As shown in FIGS. 1-8, fasteners 150 may be used to pinch inward-extending lips of the frame rail's horizontal legs 130, in order to secure the wiring mount 100 to frame rail 130.

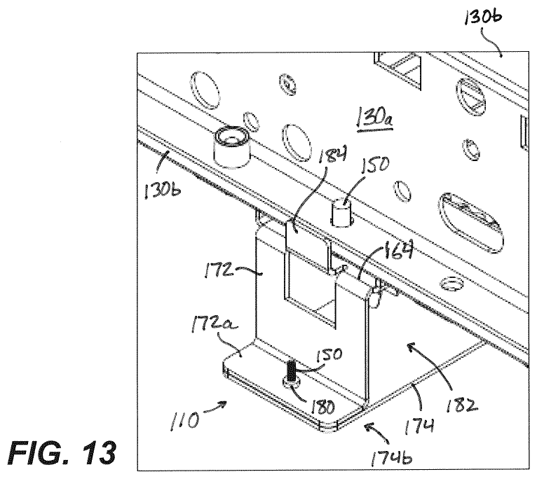

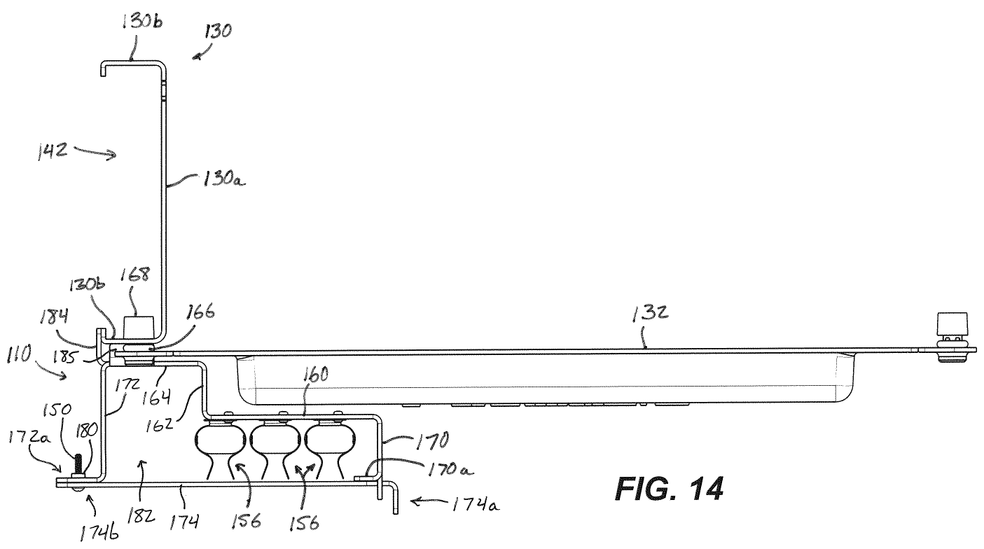

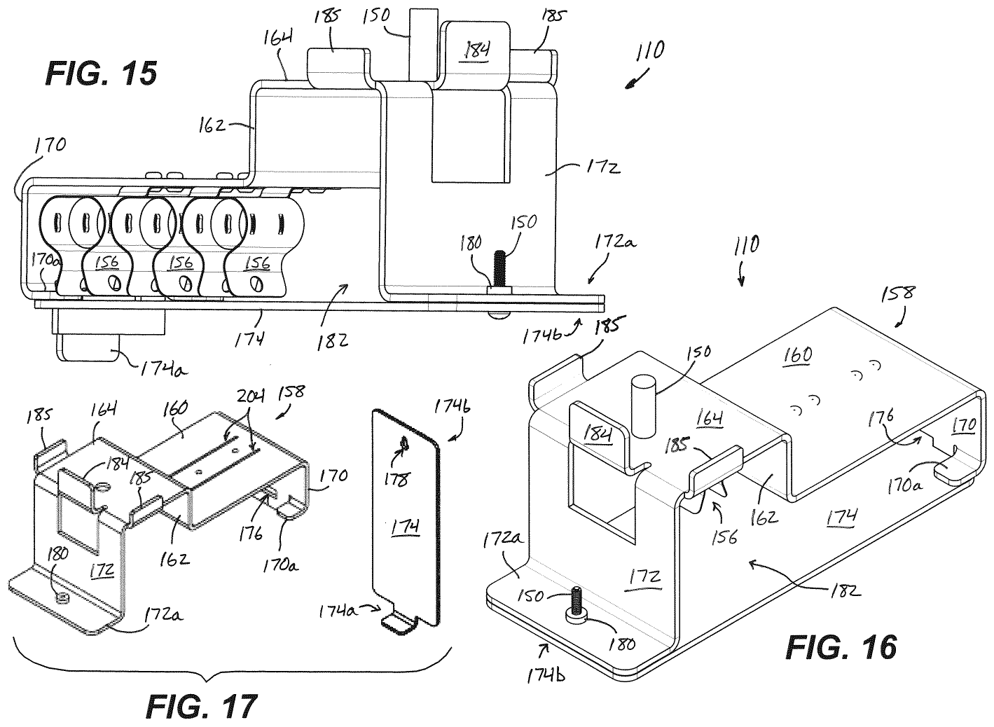

Wiring mount 110 is designed to support cables 134 and wiring 136 in a horizontal arrangement, and is configured for attachment to the lower leg 130b of frame rail 130, as shown in FIGS. 1-8 and 12-16. Referring to FIGS. 14-17, wiring mount 110 has a bracket 158 with cable support plate 160 and a mounting leg 162 that extends perpendicularly away from the cable support plate 160. A mounting foot 164 extends horizontally away from the mounting leg 162 and cable support plate 160, and includes a fitting 166 in the form of a rubber grommet through an opening, for receiving a fastener that is used to secure bracket 158 to the underside of the frame rail's lower horizontal leg 130b having its own fastener-receiving fitting 168. A first plate-supporting leg 170 extends perpendicularly away from cable support plate 160, opposite mounting leg 162, and a second plate-supporting leg 172 extends perpendicularly downwardly from an outboard end of mounting foot 164. First and second plate-supporting legs 170, 172 have respective mounting feet 170a, 172a at the same elevation, the mounting feet engaging opposite end portions of a closure plate 174.

Closure plate 174 includes a tabbed end 174a for insertion through a slot 176 formed in first plate-supporting leg 170 near foot 170a (FIG. 17), and an opposite end 174b with keyhole opening 178 for receiving a fastener 150 that also extends through a fitting 180 in the second plate-supporting leg's mounting foot 172a. By securing closure plate 174 to bracket 158, any cables or wires held in the cable retainers 156 that are coupled to cable support plate 160 will be prevented from falling out of the cable retainers 156. Closure plate 174 and the mounting leg 162, mounting foot 164, and the second plate-supporting leg 172 of bracket 158 cooperate to define a larger pass-through opening 182 that may be used to support additional cables, wiring, conduits, control boxes, or the like. An upward-extending tab 184, where mounting foot 164 meets second plate-supporting leg 172, can provide a locating and supporting feature by engaging the upward-extending lip of the frame rail's lower leg 130b, as shown in FIGS. 13 and 14. A pair of upwardly-extending spacer tabs 185 are located on opposite sides of mounting foot 164 with a fastener 150 in between. Spacer tabs 185 engage the bottom surface of the lower leg 130b of frame rail 130, to prevent over-compressing fitting 166 while tightening the fastener 150 in fastener-receiving fitting 168 (FIG. 14).

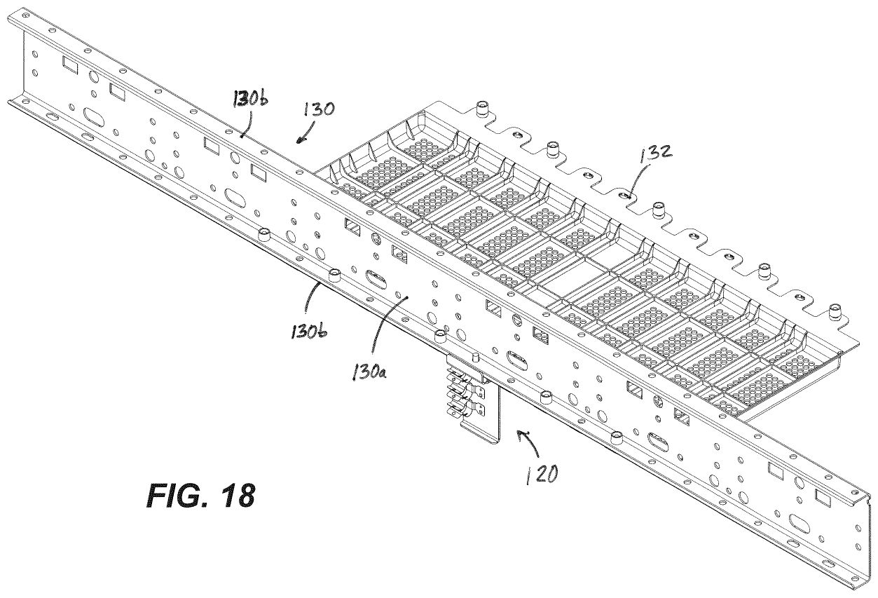

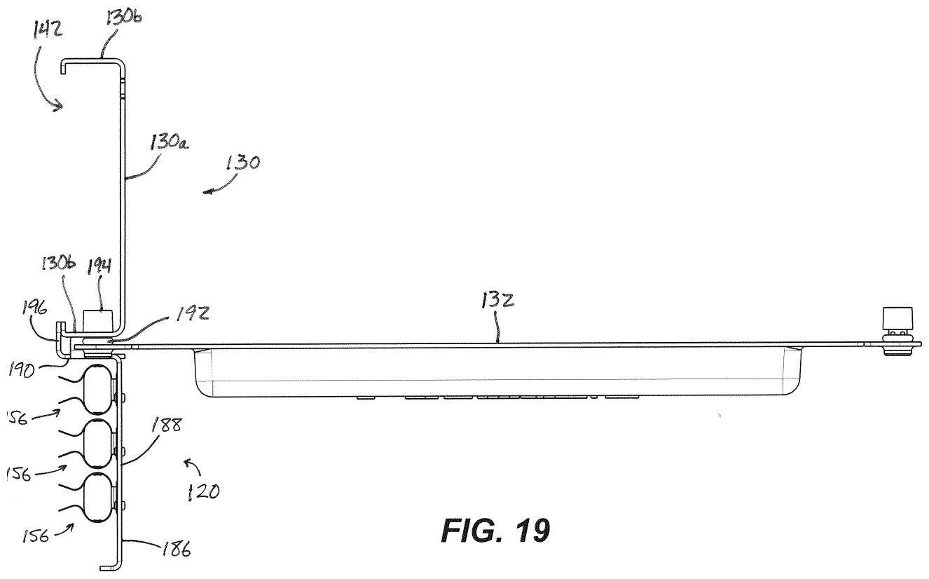

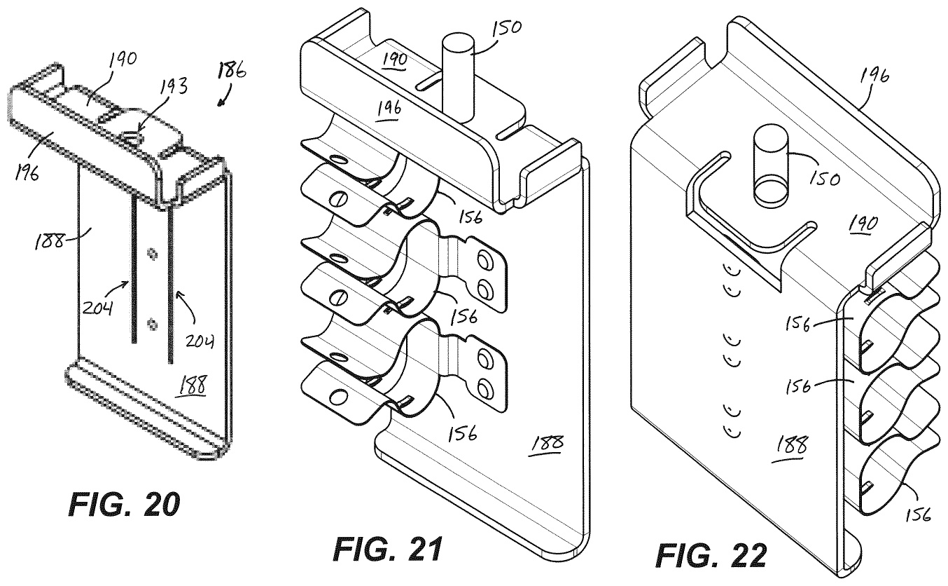

Wiring mount 120 is designed to support cables 134 and wiring 136 in a vertical arrangement, and is configured for attachment to the lower leg 130b of frame rail 130, as shown in FIGS. 1-8, 18, and 19. Wiring mount 120 has a bracket 186 with cable support plate 188 that receives a plurality of cable retainers 156 in vertical stacked arrangement. A mounting leg 190 is angled relative to cable support plate 188 so as to extend horizontally away, for coupling to the frame rail's lower horizontal leg 130b using a fastener that passes through a fitting 192 in the form of a rubber grommet through an opening 193 in mounting leg 190. The fastener is used to secure bracket 186 to the underside of the frame rail's lower horizontal leg 130b, which has its own fastener-receiving fitting 194. An upward-extending tab 196 at an outboard end of mounting leg 190 can provide a locating and supporting feature by engaging the upward-extending lip of the frame rail's lower leg 130b, as shown in FIG. 19.

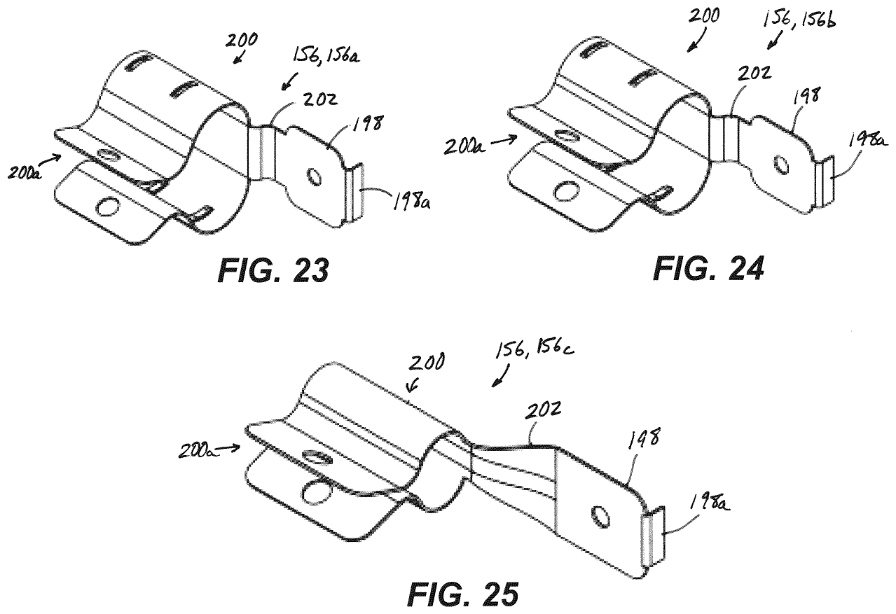

Referring now to FIGS. 23-25, several cable retainers 156 are shown with varying dimension, including two larger cable retainers 156a, 156b (FIGS. 23 and 24), and a smaller cable retainer 156c with a longer lateral offset (FIG. 25). Each cable retainer 156 has a base 198, a resilient C-shaped clip portion 200 that defines a channel opening 200a, and a lateral offset 202 extending between base 198 and clip portion 200. Cable retainers 156 may be made from resilient material such as spring steel or resinous plastic, so that the opposing legs of the clip portions 200 may flex apart and return during insertion or removal of cables or wiring. Lateral offsets 202 typically extend both laterally and vertically away from the respective bases 198 so that no part of clip portions 200 lie in the same plane as their corresponding base 198. This allows for some flexing of lateral offsets and movement of the clip portions 200 relative to their respective bases 198 during insertion or removal of cables or wiring at the clip portions 200. A rearward-extending tab 198a at each base 198 is configured to engage a slot 204 formed in the cable support plate 144, 160, 188 to which the cable retainer 156 is mounted. Tabs 198a and slots 204 allow an installer to set the orientation of each cable retainer 156 in one of two positions at the cable support plate 144, 160, 188.

Changes and modifications in the specifically described embodiments can be carried out without departing from the principles of the present invention which is intended to be limited only by the scope of the appended claims, as interpreted according to the principles of patent law including the doctrine of equivalents.

1. A wiring mount for conveyor systems, said wiring mount comprising:
a bracket having a cable support plate and at least one mounting leg angled to extend away from said cable support plate, said mounting leg configured for coupling said cable support plate to a conveyor or conveyor segment;
a fitting at said mounting leg, said fitting configured to receive or support a fastener for coupling to the conveyor or conveyor segment; and
a cable retainer having a base and a resilient clip portion extending away from said base and configured to releasably receive an electrical cable;
wherein said base is configured for coupling to said cable support plate, and said resilient clip portion defines a channel opening that opens away from said main support plate.

2. The wiring mount of claim 1, wherein when said base is coupled to said cable support plate, said resilient clip portion extends laterally outboard of said cable support plate.

3. The wiring mount of claim 1, wherein when said base is coupled to said cable support plate, said resilient clip portion is spaced away from said cable support plate.

4. The wiring mount of claim 1, wherein said bracket further comprises a closure plate and a closure plate receiver leg, said closure plate receiver leg angled to extend away from said cable support plate and said closure plate configured to removably couple to said closure plate receiver leg.

5. The wiring mount of claim 4, wherein when said closure plate is coupled to said closure plate receiver leg, said closure plate extends along the channel opening to restrict access to said channel opening.

6. The wiring mount of claim 4, wherein said closure plate receiver leg and said closure plate comprise respective compatible coupler portions configured to engage one another when said closure plate is coupled to said closure plate receiver leg.

7. The wiring mount of claim 6, wherein said compatible coupler portions comprise a slot formed at said closure plate receiver leg and a tab formed at said closure plate.

8. The wiring mount of claim 1, wherein said mounting leg comprises at least two spaced-apart mounting feet.

9. The wiring mount of claim 8, wherein said at least two spaced-apart mounting feet are generally parallel to said cable support plate and are spaced from said cable support plate by different distances.

10. A wiring mount for conveyor systems, said wiring mount comprising:
a cable support plate having opposite end portions;
a mounting leg at each of said opposite end portions and extending away from said cable support plate, wherein said mounting leg is configured to be secured to a conveyor module;
a pair of tab-receiving slots formed in said cable support plate and extending between said opposite end portions; and
a cable retainer comprising a base, a tab extending away from said base, and a resilient clip portion spaced from said tab, extending away from said base, and configured to releasably receive an electrical cable, wherein said cable retainer is releasably securable to said cable support plate in either of at least two different orientations;
wherein said tab of said cable retainer is received in one of said tab-receiving slots upon securing said cable retainer base to said cable support plate according to the orientation of said cable retainer.

11. The wiring mount of claim 10, further comprising first and second mounting feet at each of said mounting legs, said first mounting feet spaced from said cable support plate by a first distance and said second mounting feet spaced from said cable support plate by a second distance that is less than the first distance.

12. The wiring mount of claim 11, further comprising a plurality of fastener openings formed in spaced arrangement along said cable support plate and disposed between said pair of tab-receiving slots.

13. The wiring mount of claim 11, wherein at least one of said mounting legs is configured to temporarily support a cable below said cable retainer.

14. A wiring mount for conveyor systems, said wiring mount comprising:
a cable support plate having upper and lower end portions;
a mounting leg at said upper end portion and extending away from said cable support plate, wherein said mounting leg is configured to be secured to a conveyor module;
an upward-extending tab at an outboard end of said mounting leg, said upward-extending tab having a first height;
a pair of spacer tabs extending upwardly from opposite sides of said mounting leg, said spacer tabs each having a second height that is less than said first height, wherein said spacer tabs are configured to engage a portion of a conveyor module and said upward-extending tab is configured to extend upwardly along the portion of the conveyor module;
a cable retainer comprising a base and a resilient clip portion extending away from said base and configured to releasably receive an electrical cable, wherein said cable retainer is releasably securable to said cable support plate in either of at least two different orientations.

15. The wiring mount of claim 14, wherein:
said cable support plate comprises a pair of tab-receiving slots extending between said opposite end portions;
said cable retainer comprises a tab extending away from said base at an opposite side of said base from said resilient clip portion; and
said tab of said cable retainer is receivable in one of said tab-receiving slots, according to the orientation of said cable retainer, upon securing said cable retainer base to said cable support plate.
